(19) United States
(12) Patent Application Publication
(10) Pub. No.: US 2023/0024137 A1
(43) Pub. Date: Jan. 26, 2023

(54) PERSONAL MASSAGER

(71) Applicant: Uccellini Inc., Bend, OR (US)

(72) Inventors: Blake Michael Larkin, Eugene, OR (US); Avery Dawn Smith, Albany, OR (US); Mazie Houchens, Corvallis, OR (US); Wesley Donal Adreon, Bend, OR (US)

(21) Appl. No.: 17/383,630

(22) Filed: Jul. 23, 2021

(51) Int. Cl. A61H 19/00; A61H 23/02

(52) U.S. Cl. CPC A61H 19/44; A61H 23/02; A61H 2201/1207; A61H 2201/5023

(57) ABSTRACT

Disclosed embodiments provide a personal massager device. The massager device includes a stimulator, which is G-spot stimulator, clitoral stimulator, or a prostate stimulator. The stimulator includes an enclosure having an opening. A post is disposed within the enclosure. The post has a groove formed in the side at a non-orthogonal angle with respect to a longitudinal axis of the post. A ball is disposed within the groove. The ball protrudes outside the opening of the enclosure. The post is rotated in a continuous direction by the motor, and as it does so, the ball traverses a path. A sheath is disposed tightly over the enclosure. The ball presses the sheath against the G-spot or prostate of the user, providing stimulation.

### FIELD

The present invention relates generally to personal massagers, and more particularly, to personal massagers for G-spot, clitoral stimulation, or prostate message.

### BACKGROUND

There are various devices available for use by for sexual stimulation. They are typically configured stimulate the clitoris, the Grafenberg Spot (the “G-spot,” a nerve reflex area inside the vagina along the anterior surface), or the prostate (a gland surrounding the neck of the bladder). Products for G-spot or prostate massage are entirely manually operated, or are provided with internal motors that achieve stimulation by shape, texture and vibration. There exists a need for improvements in devices for stimulation of the G-spot, clitoral stimulation, and the prostate.

### SUMMARY

In one embodiment, there is provided a massager device, comprising: an enclosure comprising an opening, wherein the enclosure is an elongate shape; a post disposed within the enclosure, wherein the post comprises a side surface, and wherein the side surface of the post comprises a groove at a non-orthogonal angle with respect to a longitudinal axis of the post; a ball disposed within the groove, wherein the ball protrudes outside the opening of the enclosure; a driver; and an elastic sheath disposed at least over the opening.

In another embodiment, there is provided a massager device, comprising: an enclosure comprising an opening, wherein the enclosure is an elongate shape; a post disposed within the enclosure, the post comprising a side surface, and a groove formed within the side surface of the post at a non-orthogonal angle with respect to a longitudinal axis of the post; a ball disposed within the groove, wherein the ball protrudes outside the opening of the enclosure; a motor, the motor mechanically coupled to the post; an elastic sheath disposed at least over the opening and covering the ball; a processor; and a memory coupled to the processor, wherein the memory contains instructions, that when executed by the processor, rotate the motor in a continuous direction such that the ball oscillates on a path between a start range position and an end range position.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1A shows a front view of a massager device in accordance with additional embodiments of the invention, without a sheath thereon for clarity.

FIG. 1B shows a side view of the massager device of FIG. 1A.

FIG. 2A shows a side view of a partial assembly of a massager device with a post in a first position.

FIG. 2B shows a side view of a partial assembly of a massager device with a post in a second position.

FIG. 3A shows a side view of a partial assembly of a massager device with a post in a first position with a ball.

FIG. 3B shows a side view of a partial assembly of a massager device with a post in a second position with a ball.

FIG. 3C shows details of movement of a ball from the first position to the second position.

FIG. 4 shows a top-down view of a partial assembly of a massager device in accordance with embodiments of the present invention.

FIG. 5 is a cutaway view of a partial assembly of a massager device in accordance with embodiments of the present invention showing placement of a vibrator.

FIG. 6A-FIG. 6C show views of a post in accordance with embodiments of the present invention.

FIG. 7 is a side cutaway view of a massager device in accordance with embodiments of the present invention.

FIG. 8 shows additional details of a post in accordance with embodiments of the present invention.

FIG. 9A shows details of a post having a straight path.

FIG. 9B shows details of a post having a wavy path.

FIG. 10 shows an embodiment utilizing two balls.

FIG. 11 is an embodiment showing a ball utilizing a smooth cap.

FIG. 12 is an embodiment showing a ball utilizing a cap with small bumps.

FIG. 13 is an embodiment showing a ball utilizing a cap with large bumps.

FIG. 14 shows example track profiles in accordance with embodiments of the present invention.

FIG. 15 shows an embodiment having a sheath extending around the enclosure.

FIG. 16 shows an additional embodiment that includes a clitoral massager.

FIG. 17 is a block diagram showing components of an embodiment of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide an improved personal massager device. The massager device includes a stimulator, which is G-spot stimulator, clitoral stimulator, or a prostate stimulator. The stimulator includes an enclosure having an opening. A post is disposed within the enclosure. The enclosure may be of an elongate shape. The post has a groove formed in the side at a non-orthogonal angle with respect to a longitudinal axis of the post. A ball is disposed within the groove. The ball protrudes outside the opening of the enclosure. During operation, the post is rotated in a continuous direction by the motor, and as it does so, the ball traverses a path. An elastic sheath is disposed tightly over the enclosure. “Elastic sheath” herein is a material that is expandable by force (such as by the ball), but returns to its original size when the force (e.g., of the ball) is removed. The ball presses the sheath against the G-spot or prostate of the user, providing stimulation. In embodiments, the post is rotated continuously in one direction, while providing a reciprocal motion of a ball which is applied to the skin of a user to provide a massaging effect. The device may also be used by inserting at least a portion of it into the vagina or anus of a user. The device may also be used as a clitoral stimulator by placing it against the clitoris of a user.

Reference throughout this specification to “one embodiment,” “an embodiment,” “some embodiments”, “embodiments,” or similar language means that a particular feature, structure, or characteristic described in connection with the embodiment is included in at least one embodiment of the present invention. Thus, appearances of the phrases “in one embodiment,” “in an embodiment,” “in some embodiments”, “in embodiments,” and similar language throughout this specification may, but do not necessarily, all refer to the same embodiment.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise.

Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, integers, steps, operations, elements, components, and/or groups thereof.

For the purposes of disclosure, the word, “substantially” is defined as “for the most part”. It means “to a great extent,” but having some room for some minor variation.

Moreover, the described features, structures, or characteristics of the invention may be combined in any suitable manner in one or more embodiments. Features, structures, or characteristics of one embodiment can be mixed and matched with features, structures, or characteristics of another embodiment. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

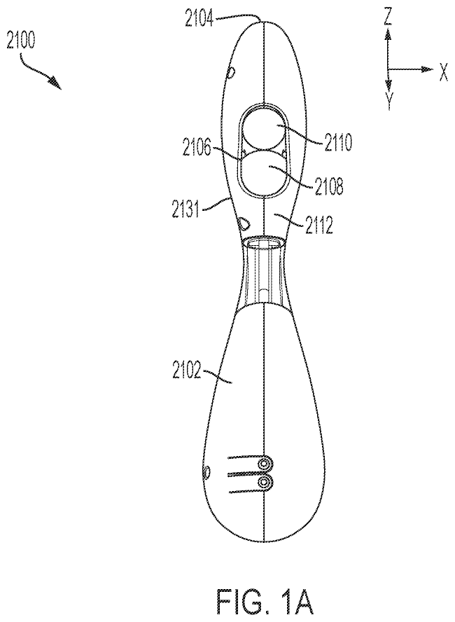

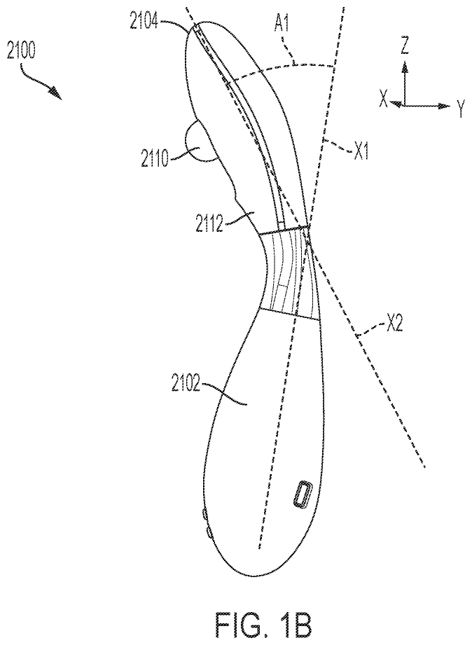

FIG. 1A shows a front view of a massager device 2100 in accordance with embodiments of the invention, without a sheath thereon for clarity. Device 2100 comprises an enclosure 2131. The enclosure 2131 includes a handle portion 2102, a tip portion 2104, and a massager portion 2112 disposed between the handle portion 2102 and the tip portion 2104. Within the massager portion 2112 is an opening 2106. A ball 2110 is disposed in a groove of a post 2108 disposed within the enclosure 2131.

FIG. 1B shows a side view of the massager device of FIG. 1A. As can be seen in FIG. 1B, the handle portion 2102 has a longitudinal axis X1, and the massage portion 2112 has a longitudinal axis X2. In embodiments, X1 and X2 are non-parallel with respect to each other, forming angle A1. In some embodiments, angle A can vary from −100 to 100 degrees. In some embodiments, angle A1 ranges from 20 degrees to 40 degrees. The angled design can make it more comfortable for a user to hold the handle portion 2102 during use. The angle A1 may be any feasible angle. For example, in some embodiments, angle A1 is zero, in which case, the device is effectively substantially “straight.”

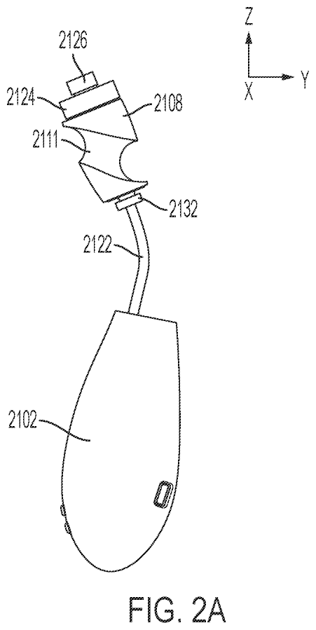

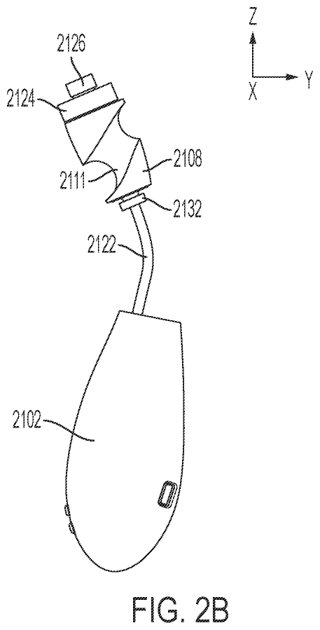

FIG. 2A shows a side view of a partial assembly of the massager device of FIGS. 1A-1B with a post 2108 in a first position. The post 2108 comprises a groove 2111 that mechanically engages with a ball (not shown). The post 2108 of the embodiment shown in FIG. 2A has a feature of enabling reciprocating motion of the ball during a continuous rotation of the post in one direction. By eliminating the need for an alternating motion of the post, mechanical reliability is improved, and the operation may be smoother with reduced noise. In embodiments, a first bearing 2124 and a second bearing 2132 are disposed on each end of the post 2108.

Embodiments may further include a vibrator disposed within the post 2108. In some embodiments, a vibrator motor is disposed within a cavity within the post 2108 and mounted concentrically within the post, and a vibrator weight 2126 is mechanically coupled to the vibrator motor and disposed outside the post 2108 as shown in FIG. 2A.

In embodiments, a flexible driveshaft 2122 mechanically couples the post 2108 to a massager motor disposed within the handle portion 2102. The flexible driveshaft 2122 may include a stationary protective outer casing comprised of copper twisted wires that utilizes fittings which keep it stationary during use. In some embodiments, one or more electrical wires may be affixed to the stationary protective outer casing in order to provide power to the vibrator.

FIG. 2B shows a side view of the partial assembly of FIG. 2A with the post 2108 in a second position after 180 degrees of rotation as compared with FIG. 2A. It should be recognized that “first position” and “second position” are for purpose of description, and are not meant to be limiting.

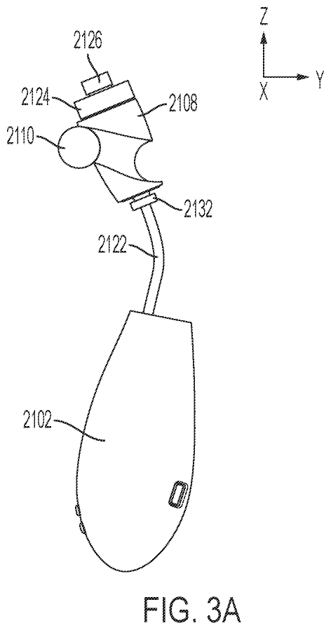

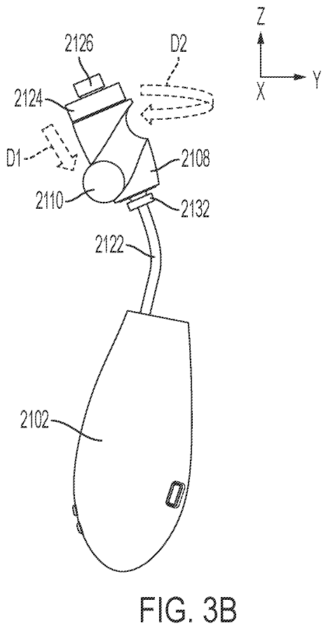

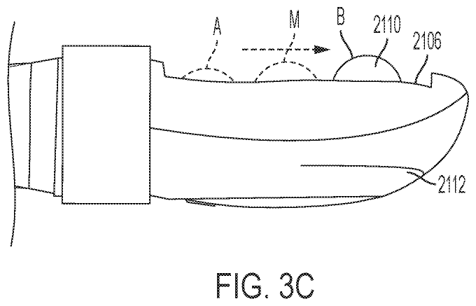

FIG. 3A shows a side view of a partial assembly of a massager device with a post in a first position with a ball 2110. FIG. 3A is similar to FIG. 2A, except for the addition of the ball 2110.

FIG. 3B shows a side view of a partial assembly of a massager device with a post in a second position with a ball. FIG. 3B is similar to FIG. 2B, except for the addition of the ball 2110. As compared with FIG. 3A, the post 2108 has rotated 180 degrees as indicated by arrow D2. As a result of the rotation of post 2108, ball 2110 has moved in the direction indicated by arrow D1 closer to the handle portion 2102 as compared with the configuration of FIG. 2A.

FIG. 3C shows details of movement of a ball 2110 from the first position to the second position. In FIG. 3C, the ball moves from a position indicated as A to the position indicated as B, and having a midpoint position of travel indicated as M, which is equidistant between position A and position B. The ball 2110 oscillates in a reciprocal motion between the two positions as the post 2108 rotates. A portion of the ball 2110 protrudes from opening 2106 located in the massager portion 2112. In embodiments, the massager portion (or at least the ball and opening) is surrounded by an elastic sheath that enables the movement of the ball to be felt by a user, while providing a safe and washable surface that makes direct contact with the skin of the user. Thus, in embodiments, the motor is configured to rotate in a continuous direction such that the ball oscillates on a path between a first position and a second position.

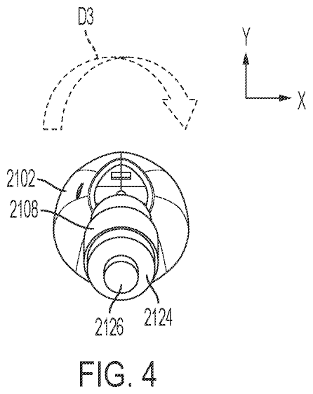

FIG. 4 shows a top-down view of a partial assembly of a massager device in accordance with embodiments of the present invention. In this view, the vibrator weight 2126 can be seen disposed concentrically with respect to post 2108, with annular bearing 2124 disposed between the post 2108 and the vibrator weight 2126. In embodiments, the vibrator weight has a non-uniform, asymmetric density, such that as it rotates in the direction indicated by arrow D3, vibration is imparted to the post 2108, and to the ball 2110 (FIG. 3B). In some embodiments, the vibration feature can be used independently from the massage feature provided by the ball. In some embodiments, the vibration feature can be used simultaneously with the massage feature provided by the ball.

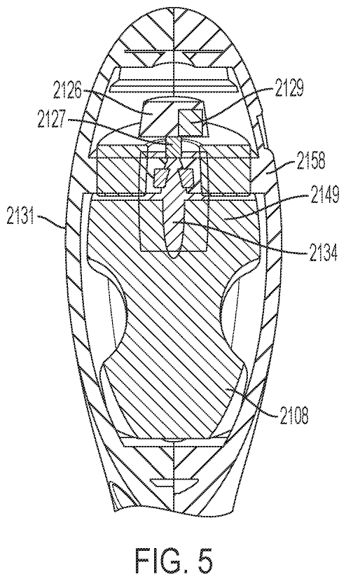

FIG. 5 is a cutaway view of a partial assembly of a massager device in accordance with embodiments of the present invention showing placement of a vibrator. A vibrator motor 2134 is mounted to crossbeam 2158 of the enclosure 2131 such that the motor 2134 is at least partially disposed within a cavity 2149 formed concentrically in the post 2108. In some embodiments, the motor 2134 is fully disposed within the post 2108. A shaft 2127 couples vibrator weight 2126 to the vibrator motor 2134. The vibrator weight 2126 may have a high-density portion 2129 disposed off-center with respect to shaft 2127, such that as the vibrator weight 2126 rotates, it imparts vibrations to the post 2108, proportional to the speed of rotation of vibrator motor 2134. These vibrations can create a pleasurable sensation for a user.

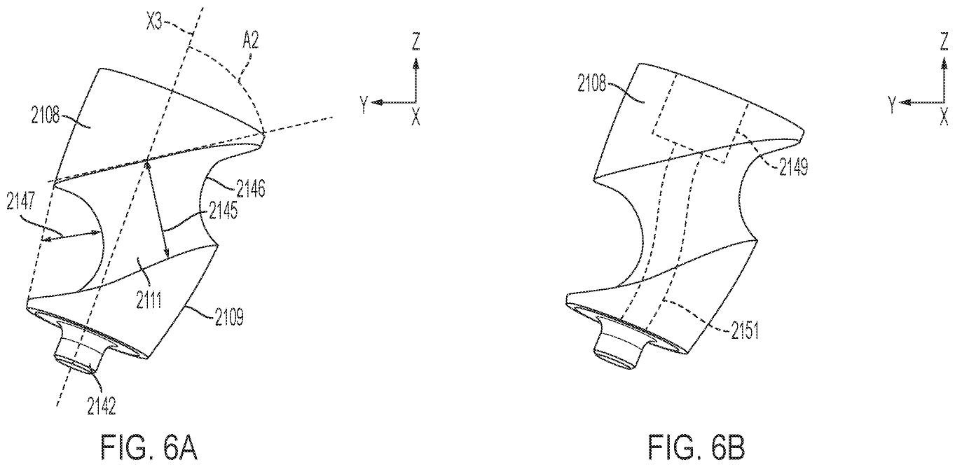

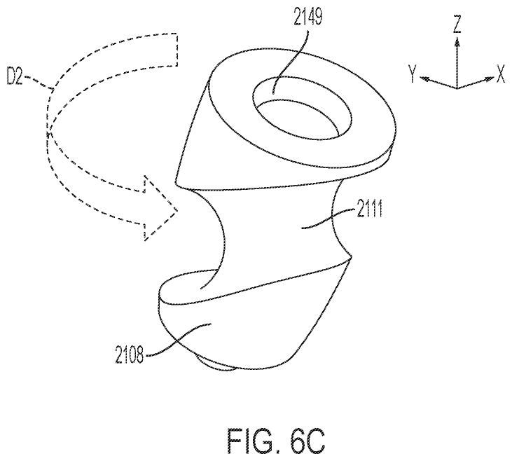

FIG. 6A-FIG. 6C show views of a post in accordance with embodiments of the present invention. Referring now to FIG. 6A, a post 2108 is shown. Post 2108 has longitudinal axis X3. The post 2108 comprises a side surface 2109. A groove 2111 is formed around the post 2108 at a non-orthogonal angle A2 with respect to the longitudinal axis X3. In embodiments, angle A2 can range from 45 degrees to 80 degrees. The groove 2111 extends completely around the side surface 2109 of the post 2108. The groove 2111 enables the post to rotate continuously in one direction while still providing a reciprocal motion of the ball. A driveshaft may be affixed to coupler 2142 to spin the post during operation. The groove 2111 has a width 2145 and a depth 2147 with a curved floor surface 2146 that is well-suited to accommodate a spherical ball, as well as other suitable shapes.

Referring to FIG. 6B, the post 2108 is shown including the internal passage 2151 suitable for routing wires to the vibration motor which is installed in concentric cavity 2149.

Referring now to FIG. 6C, the post 2108 is shown in a perspective view. The groove 2111 extends completely around the post 2108. Concentric cavity 2149 allows the vibrator motor (2134 of FIG. 5) to occupy space within the cavity, thereby making an efficient use of space and reducing the overall size of the device. Thus, in embodiments, the vibrator comprises a vibrator motor that is disposed within a concentric opening 2149 in the post 2108.

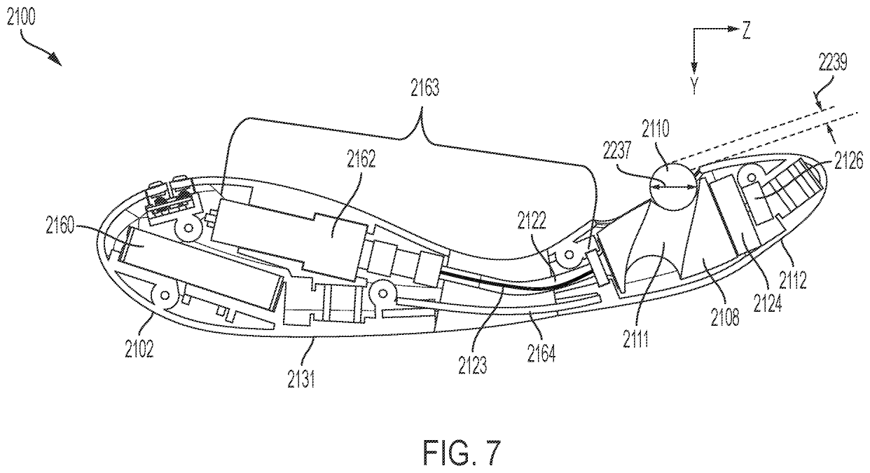

FIG. 7 is a side cutaway view of a massager device 2100 in accordance with embodiments of the present invention. Within the handle portion 2102 of the enclosure 2131 there is a battery 2160, and a massager motor 2162 that drives the post 2108. The battery 2160 is used to power the motors and other electronic components of the massager device 2100. The massager motor 2162 is coupled to a flexible driveshaft 2122. The driver 2163, comprising the massager motor 2162 and flexible driveshaft 2122 (and any other linkages or couplings), causes rotational motion of the post 2108. An electrical conduit 2123 provides power to the vibration motor (2134 of FIG. 25) that is disposed within the post 2108. A flexible spar 2164 connects the handle portion 2102 to the massage portion 2112. In embodiments, the flexible spar 2164 has a memory such that when bent, it remains substantially in the bent position such that a user can set a desired angle. The spar may be made of a metal wire, a group of wires wrapped around one another, or another suitable material. The post 2108 is coupled to the flexible driveshaft 2122. The ball 2110 is disposed within the groove 2111 of the post 2108. The vibration weight 2126 is coupled to the vibration motor in the post 2108. Bearing 2124 is disposed between the post 2108 and the vibration weight 2126.

A feature of the embodiment of FIGS. 1-7 is that the post can rotate in a continuous direction (rather than reciprocal) and still achieve the reciprocating motion of the ball. However, embodiments with the post 2108 can also operate with alternating direction to enable a fine-tuned range control. In some embodiments, the user can select, from a user interface, in which direction the post moves. The embodiments of FIGS. 1-7 can be used in a standalone device such as depicted in FIG. 7. Additionally, the post of the embodiments shown in FIGS. 1-7 can be used in a device that further includes a clitoral stimulator.

Still referring to FIG. 7, ball 2110 has diameter 2237. In embodiments, diameter 2237 has a value ranging from 12 millimeters to 30 millimeters. In some embodiments, diameter 2237 has a value ranging from 18 millimeters to 26 millimeters. Ball 2110 protrudes from the massage portion 2112 by a protrusion distance 2239. The protrusion distance 2239 can vary as the ball 2110 moves back and forth during operation. In embodiments, the protrusion distance has a value ranging from 4 millimeters at a minimum value to 18 millimeters at a maximum value. In some embodiments, the protrusion distance has a value ranging from 6 millimeters at a minimum value to 12 millimeters at a maximum value. In embodiments, the ratio of the protrusion distance 2239 to the diameter 2237 of ball 2110 ranges from 31.5 percent at the position indicated as A in FIG. 3C to 62.5 percent at the position indicated as C in FIG. 3C. In some embodiments, the ratio of protrusion distance 2239 to the diameter 2237 of ball 2110 is 48 percent at the position indicated as M in FIG. 3C.

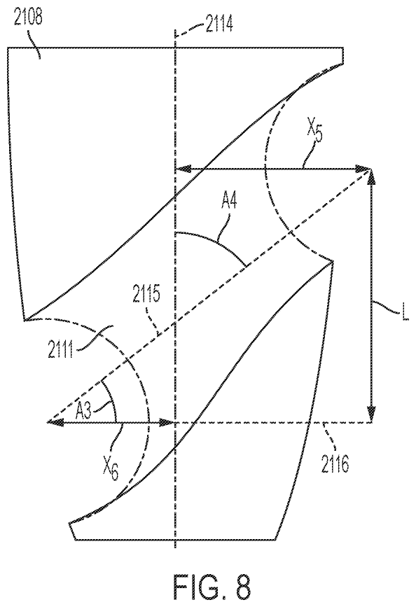

FIG. 8 shows additional details of a post 2108 in accordance with embodiments of the present invention. Post 2108 comprises groove 2111 formed therein. A ball (such as 2110 of FIG. 3A) has a length of travel L. Additionally, during operation, a ball varies in distance from the post center 2114 as the post 2108 rotates. This distance is referred to as a “departure distance.” The groove 2111 is formed such that the ball has a maximum departure distance X5 and a minimum departure distance X6. A center line 2115 parallel to the groove 2111 forms an angle A3 with horizontal axis 2116, where angle A3 is defined as:

A3=tan⁻(L/(X₅+X₆)); and

A4=90−A3

In some embodiments, the values of A3 and A4 may vary along the length of the post 2108. In some embodiments, the sum of A3 and A4 may equal 90 degrees. In other embodiments, the sum of A3 and A4 may not equal 90 degrees.

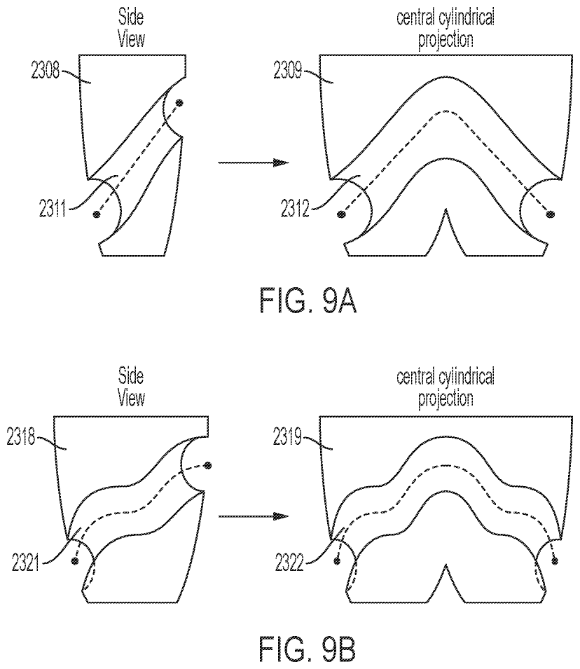

FIG. 9A shows details of a post 2308 having a groove 2311 with a straight path. The rendering 2309 shows the post 2308 in a central cylindrical projection, as if the cylindrical post was unrolled, such that the full travel path of the groove 2311 can be visualized at 2312. Post 2308 is similar to post 2108 shown in FIG. 8.

FIG. 9B shows details of a post 2318 having a groove 2321 with a wavy path. The rendering 2319 shows the post 2318 unrolled, such that the full travel path of the groove 2321 can be visualized at 2322.

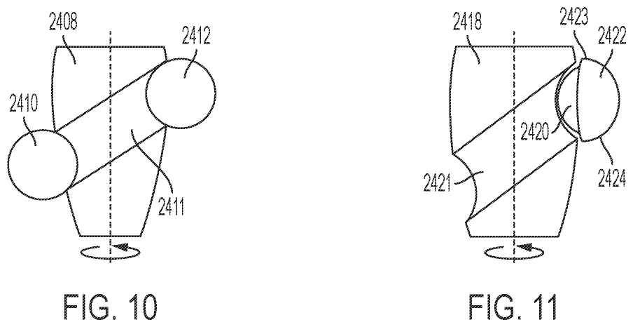

FIG. 10 shows an embodiment utilizing two balls. As shown in FIG. 10, post 2408 includes a first ball 2410 and a second ball 2412, each disposed in groove 2411. Embodiments may have more or fewer balls than shown in FIG. 10.

FIG. 11 is an embodiment showing a ball utilizing a smooth cap. As shown in FIG. 11, post 2418 includes ball 2420 having oversized cap surface 2422. The cap surface has a convex shape. The edges 2423 and 2424 of the cap exceed the width of the groove 2421 such that it cannot “fall into” the groove. The ball 2420 is disposed in groove 2421.

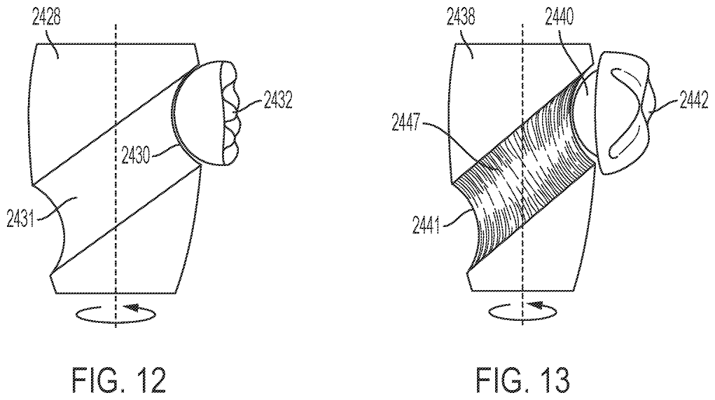

FIG. 12 is an embodiment showing a ball having a textured cap with small bumps on the surface facing away from the groove. As shown in FIG. 12, post 2428 includes ball 2430 having small bumps formed on surface 2432. The ball 2430 is disposed in groove 2431.

FIG. 13 is an embodiment showing a ball having a textured cap with large bumps. As shown in FIG. 13, post 2438 includes ball 2440 having large bumps formed on surface 2442. The ball 2440 is disposed in groove 2441. In embodiments, the surface 2447 of groove 2441 is textured, creating additional vibration sensations that are imparted to the user during operation of disclosed embodiments.

A textured cap is not limited to bumps as disclosed herein. In some embodiments, the texture may include channels, linear or circular protrusions, or other designs, etc.

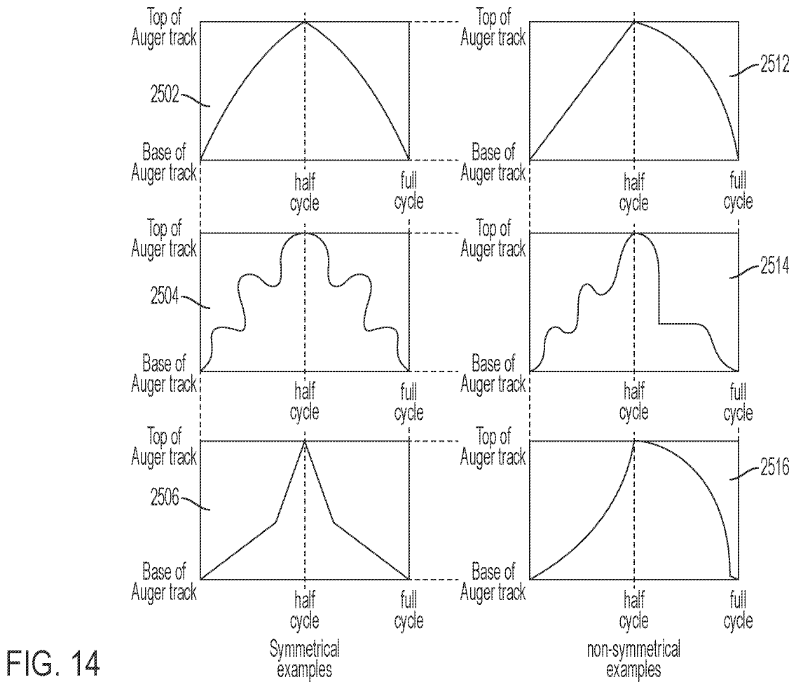

FIG. 14 shows example track profiles in accordance with embodiments of the present invention. These track profiles represent an unrolled rendering such as shown in FIG. 9A and FIG. 9B. Profile 2502 shows a symmetrical linear path. Profile 2512 shows an asymmetrical path having a linear portion up to the half cycle point, and then a different curve portion from the half cycle point to the full cycle point. Profile 2504 shows a wavy symmetrical path. Profile 2514 shows a wavy asymmetrical path. Profile 2506 shows a symmetrical path with angled corners. Profile 2516 shows an asymmetrical curved path.

The disclosed track profiles are exemplary, and other track profiles are possible in disclosed embodiments. The track profiles, number of balls, type of balls, and surface texture of the groove may be combined in various ways to create embodiments that impart various vibrations and/or sensations to the user to provide enhanced enjoyment and pleasure while using disclosed embodiments.

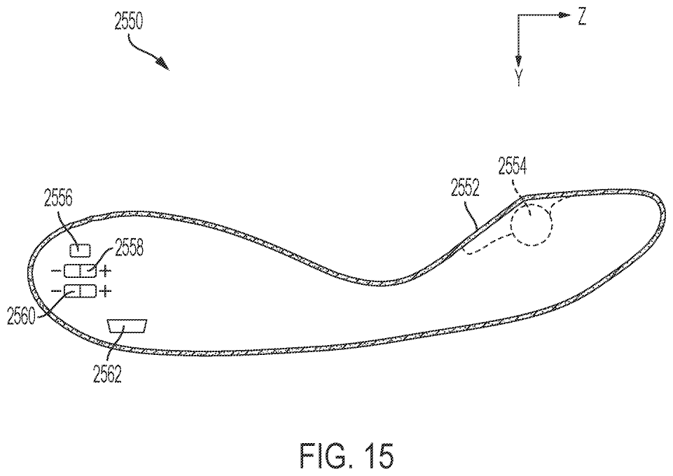

FIG. 15 shows an embodiment having a sheath extending around the enclosure. Device 2550 includes components similar to device 2100 as shown in FIG. 7, and further includes an elastic sheath 2552 disposed over the enclosure and the ball 2554. The elastic sheath 2552 keeps the ball 2554 engaged within the groove the post 2108 (FIG. 3A) during operation. That is, the elastic sheath is configured and disposed to exert a force on the ball to keep the ball engaged with the groove (2111 of FIG. 2B). A charging port 2562 may be disposed on the device 2550 in order to receive power to charge an internal rechargeable battery. Charging port 2562 may be a USB-C port, or other suitable port type. Alternatively, charging port 2562 may be a magnetic indication charging port to support wireless charging. Device 2550 may include an onboard user interface that includes a plurality of controls to allow operation of the device. The controls may include a power button 2556 to turn the device on or off. The controls may further include a massager speed control button 2558. In embodiments, button 2558 may be a rocker-type button that a user can press on one side with the “+” to increase massager speed, and press on the other side with the “−” to reduce massager speed. The controls may further include a vibrator speed control button 2560. In embodiments, button 2560 may be a rocker-type button that a user can press on one side with the “+” to increase vibrator speed, and press on the other side with the “−” to reduce vibrator speed. The location of the buttons and charging port are exemplary, and other embodiments may include different arrangements of buttons and charging port locations. The plus and minus markers are used here for description, and other designations may be substituted within the scope of the invention. In addition, the button may be a different size, may be more than one button, or may not be present as the device may be remote-controlled.

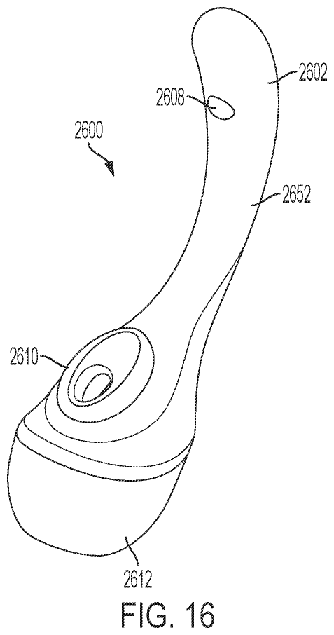

FIG. 16 shows an additional embodiment of a device 2600 that includes a clitoral massager. Device 2600 includes a shaft portion 2602 that utilizes a post such as shown at 2108 of FIG. 8, with a ball 2608 (protruding from under the sheath) that is used for massaging a G-spot area. The device 2600 comprises a base portion 2612. In embodiments, the enclosure that houses the internal components may be covered in a sheath 2652. A cup 2610 is disposed on the base section. The cup 2610 is configured and disposed to apply pressure to the clitoral region of a user. In this way, a user can experience a simultaneous G-spot stimulation and clitoral stimulation using disclosed embodiments. An example clitoral massager may be an air pressure stimulator as described in U.S. patent application Ser. No. 16/985,564, filed, Aug. 5, 2020, the entire contents of which is incorporated herein by reference.

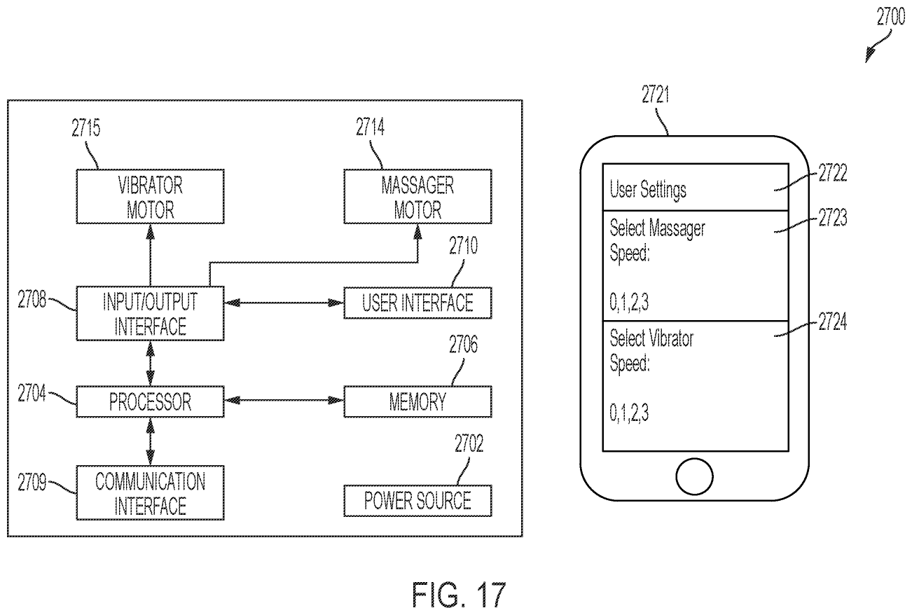

FIG. 17 is a block diagram showing components of an embodiment of the present invention. Device 2700 includes a processor 2704 and a memory 2706 coupled to the processor 2704, an input/output (I/O) interface 2708 coupled to the processor 2704, and a user interface 2710 coupled to the I/O interface 2708.

A power source 2702 powers the processor 2704, motor 2714, and other electronic components. Power source 2702 may be a battery, which may be a replaceable, or internally sealed rechargeable battery. In some embodiments, the battery may be USB-chargeable, inductively chargeable, or other suitable charging mechanism now known or hereafter developed. It should be recognized that any power source, now known or hereafter developed, may be used. More than one battery may be included in some embodiments. In some embodiments, the stimulation device may be powered by alternating current power, such as 120V or 240V standard household power, with a power adapter comprising voltage regulators to convert the power to an appropriate DC level (e.g., 12V DC).

The memory 2706 may include a non-transitory computer readable medium including, but not limited to, flash, EEPROM, static ram (SRAM), or other suitable storage type. The memory 2706 contains instructions, that when executed by processor 2704, enable embodiments of the present invention. The user interface 2710 may comprise one or more buttons, lights, buzzers, liquid crystal displays, and/or other suitable components for control and operation of the device.

The massager device further includes massager motor 2714. The operational speed and/or direction of movement of massager motor 2714 may be controlled via a signal from input/output interface 2708. The massager device may further include vibrator motor 2715. The operational speed of the vibrator motor 2715 may be controlled via a signal from input/output interface 2708. The device may further include a communication interface 2709, which may support a wired and/or wireless communication protocol, including, but not limited to, Wi-Fi, Bluetooth, infrared, or other suitable communication protocol. Accordingly, in some embodiments, the user interface 2710 may not be present.

The communication interface 2709 can enable communication with a remote device 2721 such as a smartphone or tablet computer to enable additional user interface functions on the remote device. In some embodiments, the massager device 2700 may be controllable via an application on the remote device 2721, instead of, or in addition to user interface 2710.

In some embodiments, a user interface 2722 rendered on remote device 2721 may include additional options. In embodiments, the additional options include a massager speed setting 2723. The speed setting may have various available levels (e.g., level 0 (off), 1, 2, and 3). Each level may correspond to a different operational speed of motor 2714. The user interface 2722 may further include an option for a vibrator speed setting 2724. The speed setting may have various available levels (e.g., level 0 (off), 1, 2, and 3). Each level may correspond to a different operational speed of motor 2715. These settings may be stored in memory 2706, such that the preferences of the user are saved and retrieved on subsequent uses of the device.

In some embodiments, the post and the enclosure are substantially rigid, and may be made from plastic, metal, glass a composite, a combination thereof, or another suitable material. In some embodiments, the ball, and cap surface if present, are substantially rigid, and may be made from plastic, metal, glass composite, hard rubber, a combination thereof, or another suitable material. In some embodiments, the sheath may be made from a flexible and elastic material, such as plastic, rubber, or another suitable material.

Some embodiments are unitary in structure, meaning the components thereof together form a single product, rather than multiple products which may be used together by a user. Some embodiments are waterproof such that they may be washed with fluids, like soap and water. Accordingly, the sheath and any other external portions are sealed. This allows a user to clean the device thoroughly between insertions. It should be recognized that although described as applicable to massage of a G-spot, prostate, or clitoris, that embodiments may be used for stimulation of any suitable body part.

As can now be appreciated, disclosed embodiments provide improvements in G-spot and prostate massaging devices by utilizing a post that is configured for continuous rotational motion in one direction, while providing reciprocal motion of a ball, in order to provide a new level of G-spot and prostate stimulation. While the invention has been particularly shown and described in conjunction with exemplary embodiments, it will be appreciated that variations and modifications will occur to those skilled in the art.

The embodiments according to the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of the invention.

What is claimed is:

1. A massager device, comprising:
an enclosure comprising an opening, wherein the enclosure is an elongate shape;
a post disposed within the enclosure,
wherein the post comprises a side surface, and
wherein the side surface of the post comprises a groove at a non-orthogonal angle with respect to a longitudinal axis of the post;
a ball disposed within the groove, wherein the ball protrudes outside the opening of the enclosure;
a driver; and
an elastic sheath disposed at least over the opening.

2. The massager device of claim 1, wherein the elastic sheath further covers the enclosure.

3. The massager device of claim 1, wherein the driver is coupled to the post via a flexible driveshaft.

4. The massager device of claim 1, wherein at least a portion thereof is configured for insertion into a vagina of a user.

5. The massager device of claim 1, wherein at least a portion thereof is configured for insertion into an anus of a user.

6. The massager device of claim 1, wherein at least a portion thereof is configured for placement against a clitoris of a user.

7. The massager device of claim 1, further comprising a vibrator.

8. The massager device of claim 7, wherein the vibrator comprises a vibrator motor that is at least partially disposed within a concentric cavity formed within the post.

9. The massager device of claim 1, further comprising a handle.

10. The massager device of claim 1, further comprising an onboard user interface.

11. A massager device, comprising:
an enclosure comprising an opening, wherein the enclosure is an elongate shape;
a post disposed within the enclosure, the post comprising a side surface, and a groove formed within the side surface of the post at a non-orthogonal angle with respect to a longitudinal axis of the post;
a ball disposed within the groove, wherein the ball protrudes outside the opening of the enclosure;
a motor, the motor mechanically coupled to the post;
an elastic sheath disposed at least over the opening and covering the ball;
a processor; and
a memory coupled to the processor, wherein the memory contains instructions, that when executed by the processor, rotate the motor in a continuous direction.

12. The massager device of claim 11, wherein the elastic sheath further covers the enclosure.

13. The massager device of claim 11, wherein the motor is coupled to the post via a flexible driveshaft.

14. The massager device of claim 11, further comprising a vibrator.

15. The massager device of claim 14, wherein the vibrator comprises a vibrator motor that is at least partially disposed within a concentric opening in the post.

16. The massager device of claim 11, wherein the ball is a G-spot stimulator.

17. The massager device of claim 11, wherein the ball is a prostate stimulator.

18. The massager device of claim 11, wherein the ball is a clitoral stimulator.

19. The massager device of claim 15, wherein the vibrator further comprises:
a weight, the weight mechanically coupled to the vibrator motor, wherein the weight is disposed outside of the concentric opening.

20. The massager device of claim 19, further comprising an annular bearing disposed between the vibrator motor and the weight.

21. The massager device of claim 11, further comprising a handle.

22. The massager device of claim 11, further comprising an onboard user interface.

23. A massager device, comprising:
an enclosure comprising an opening, wherein the enclosure is an elongate shape;
a post disposed within the enclosure, the post comprising a side surface, and a groove formed within the side surface of the post at a non-orthogonal angle with respect to a longitudinal axis of the post;
a ball disposed within the groove, wherein the ball protrudes outside the opening of the enclosure by a protrusion distance;
a motor, the motor mechanically coupled to the post;
an elastic sheath disposed at least over the opening and covering the ball;
a processor; and
a memory coupled to the processor, wherein the memory contains instructions, that when executed by the processor, rotate the motor in a continuous direction, such that the ball oscillates on a path between a first position and a second position.

24. The massager device of claim 23, wherein a ratio of the protrusion distance to a diameter of the ball ranges from 31.5 percent to 62.5 percent.

25. The massager device of claim 23, wherein the elastic sheath is configured and disposed to exert a force on the ball to keep the ball engaged with the groove.
